(19) United States
(12) Patent Application Publication
(10) Pub. No.: US 2024/0311613 A1
(43) Pub. Date: Sep. 19, 2024

(54) APPARATUS AND METHOD FOR PROCESSING SENSOR DATA, SENSOR SYSTEM

(71) Applicant: Robert Bosch GmbH, Stuttgart (DE)

(72) Inventors: Christoph Wieland, Wiesloch (DE); Victor Pankratius, Ludwigsburg (DE)

(21) Appl. No.: 18/585,803

(22) Filed: Feb. 23, 2024

(30) Foreign Application Priority Data
Mar. 15, 2023 (DE) 10 2023 202 352.0

(51) Int. Cl. G06N 3/042

(52) U.S. Cl. CPC G06N 3/042

(57) ABSTRACT

The evaluation of sensor data in order to detect an activity. Sensor values are converted into a graph. The graph is processed using a graph neural network.

### CROSS REFERENCE

The present application claims the benefit under 35 U.S.C. § 119 of German Patent Application No. DE 10 2023 202 352.0 filed on Mar. 15, 2023, which is expressly incorporated herein by reference in its entirety.

### FIELD

The present invention relates to an apparatus and a method for processing sensor data. The present invention also relates to a sensor system comprising such an apparatus for processing sensor data.

### BACKGROUND INFORMATION

In recent years, there is an increasing desire to acquire, monitor, record, and evaluate human activities, e.g., sporting activity, using technical components. The duration and intensity of sporting activity, for instance, can be logged to provide a user with an overview of his or her training status. It is moreover also possible to monitor the execution of physical activities, for example using modern sensor technology, in order to alert a user to any errors in the execution or to encourage him or her to carry out said activities correctly.

For this purpose, the activities of the user can be acquired and evaluated using one or more sensors.

German Patent Application No. DE 10 2012 216 747 A1, for example, describes a method and an apparatus for determining a movement of a body part of a living being. Here it is proposed to acquire movements of the body part by means of sensors and compare them with comparison data.

### SUMMARY

The present invention provides an apparatus and a method for processing sensor data, as well as a sensor system. Advantageous example embodiments of the present invention are disclosed herein.

According to an example embodiment of the present invention, an apparatus for processing sensor data comprises an input device, a graph generator and a processing device. The input device is configured to receive sensor data from at least one sensor. The sensor data are provided here as time series of sensor data, wherein the sensor data are acquired at discrete points in time. The graph generator is configured to create a graph. The nodes of the graph comprise received sensor data. The processing device is configured to process the graph using a graph neural network (GNN). The processing device can thus detect an activity, in particular a human activity.

Provided according to an example embodiment of the present invention is furthermore:

A sensor system comprising at least one sensor and an apparatus according to the present invention for processing sensor data. The at least one sensor is configured to monitor a human activity. The sensor is further configured to output sensor data as time series of sensor data of the monitored human activity.

Provided according to an example embodiment of the present invention is lastly:

A method for processing sensor data comprising a step of receiving sensor data from at least one sensor. The sensor data are received here as time series of sensor data at discrete points in time. The method further comprises a step of creating a graph. The nodes of the graph here comprise respective sensor data from the at least one sensor. The method lastly comprises a step of processing the graph. The graph is processed here using a graph neural network. Thus an activity, in particular a human activity, can be detected.

To detect activities, in particular human activities, characteristics associated with the activity to be detected can be monitored and acquired by means of sensors. The acquired sensor data then have to be evaluated in a suitable manner in order to be able to identify a possible detection of an activity to be detected. In addition to conventional approaches to evaluating the sensor data, there are already a few approaches that use so-called convolutional neural networks (CNN or ConvNet). However, due to the data structure involved in monitoring human activity using sensors, both the tracking and the subsequent processing of the sensor data using such CNNs requires a relatively large amount of effort.

It is therefore one feature of the present invention to take this insight into account and to use a graph neural network (GNN) instead of a conventional CNN for the processing and evaluation of sensor data for monitoring activities, in particular human activities. Such GNNs are capable of processing data elements, such as sensor data, as nodes of a graph or network. Sensor data at a discrete point in time or a sequence of discrete points in time can be provided in the nodes of such a graph. If a plurality of sensor data are available for a point in time, for example from a plurality of sensors, they can be provided as a vector. If sensor data from a plurality of successive points in time are to be assigned to a node, this can be done in the form of the structure of a matrix, for example.

Depending on the configuration of the graph, the edges, i.e., the connections between individual nodes, can represent the temporal relationships between the sensor data in the individual nodes, for example, or possibly also specify other properties, such as similarities or deviations of the sensor data in the individual nodes.

Converting the sensor data into a graph structure and then evaluating this graph using a GNN thus enables a very efficient and precise evaluation of the sensor data. In contrast to the otherwise conventional use of a CNN, the use according to the present invention of a graph neural network in particular makes it possible to increase the efficiency and thus also the accuracy.

According to one embodiment of the present invention, each node of the graph respectively comprises sensor data from a predetermined number of successive points in time. A node can be assigned sensor data from a specified number of successive points in time and/or sensor data from a specified time window, for example. The respective time window to be considered or the start time of the sensor data can be increased successively for the individual nodes, so that the graph depicts a corresponding time period of sensor data.

According to one embodiment of the present invention, the processing device is configured to process the graph using a predefined first dependency matrix. This first dependency matrix, for instance, may characterize a similarity between two respective nodes in the graph. The respective data element of such a dependency matrix can be used to specify the change in the sensor data between the respective points in time of the nodes, for example. A value other than zero in such a dependency matrix thus corresponds to an accordingly weighted edge between two nodes.

According to one embodiment of the present invention, each node comprises sensor data from a discrete point in time. The graph here comprises a predetermined number of nodes, wherein the sensor data in the individual nodes are assigned to successive points in time. In other words, such a graph depicts the sensor data from a specified time window. As part of continuous monitoring of the sensor data, this time window can advance continuously as time progresses. Sensor data from the respective time window can thus be evaluated by the GNN.

According to one embodiment of the present invention, the processing device is configured to process the graph using a predefined second dependency matrix. The second dependency matrix specifies the edges between the nodes of the graph. The second dependency matrix can in particular be used to specify a temporal relationship between the sensor data contained in the individual nodes. This second dependency matrix can thus specify the edges between temporally adjacent nodes, for instance.

According to one embodiment of the present invention, the apparatus for processing the sensor data comprises a transformation device. The transformation device is configured to carry out a time-frequency transformation of the sensor data for the nodes of the graph. The nodes of the graph then each comprise the transformed sensor data. Data reduction can be achieved here; for example by limiting the transformed sensor data to a predefined frequency range.

According to one embodiment of the present invention, the time-frequency transformation includes a wavelet transformation. To reduce the data, only frequency components up to a predetermined cutoff frequency can be provided in the nodes.

According to one embodiment of the present invention, the apparatus for processing the sensor data comprises a preprocessing device. The preprocessing device can be configured to carry out filtering and/or preprocessing of the received sensor data. The preprocessing device can include a band-pass filter or a notch filter, for example. Suitable preprocessing or filtering of the sensor data can possibly further improve the downstream detection of activities, in particular human activities.

The sensors that provide the sensor data can in principle be any suitable sensors that are capable of acquiring characteristics for monitoring activities, in particular human activities. The sensors can, for instance, include speed sensors, acceleration sensors, magnetic field sensors, pressure sensors, a gyroscope and/or any other suitable sensors.

The above configurations and further developments can be combined with one another in any desired manner if useful. Further configurations, developments and implementations of the present invention also include not explicitly mentioned combinations of features of the present invention described above or in the following with respect to the design examples. Those skilled in the art will in particular also add individual aspects as improvements or additions to the respective basic forms of the present invention.

### BRIEF DESCRIPTION OF THE DRAWINGS

Further features and advantages of the present invention are explained in the following with reference to the figures.

FIG. 1 shows an example illustration of an application for a sensor system comprising an apparatus for processing sensor data according to one example embodiment of the present invention.

FIG. 2 shows a sensor system comprising an apparatus for processing sensor data according to one example embodiment of the present invention.

FIG. 3 shows a diagram illustrating a windowing principle as it forms the basis for an example embodiment of the present invention.

FIG. 4 shows a diagram illustrating a graph as it can form the basis for an example embodiment of the present invention.

FIG. 5 shows a diagram illustrating a graph as it can form the basis for another example embodiment of the present invention.

FIG. 6 shows a flowchart as it forms the basis for a method according to one example embodiment of the present invention.

### DETAILED DESCRIPTION OF EXAMPLE EMBODIMENTS

The principle according to the present invention for processing sensor data, in particular in the context of the detection of actions of a user, is described in the following. It goes without saying, however, that the fundamental principle according to the present invention of detecting actions can generally also be applied to the evaluation of sensor data for detecting actions in other contexts.

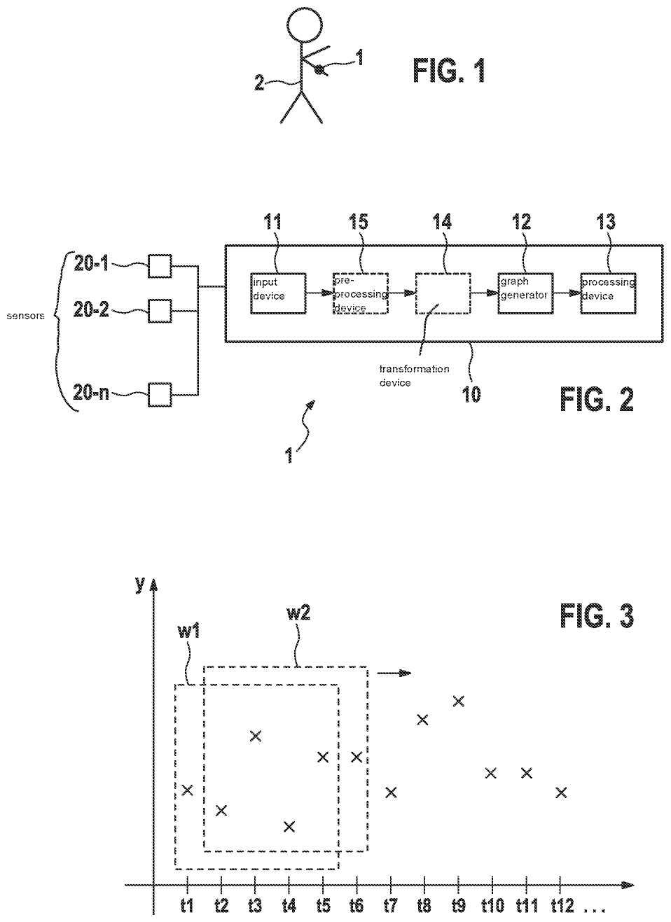

To monitor actions of a user 2 shown in FIG. 1, a variety of parameters can be acquired by means of sensors. A sensor system 1 that uses one or more sensors to acquire relevant properties and provides corresponding sensor values, for example, can be used for this purpose. The sensors and the associated apparatus for evaluating the sensor data can be integrated together in a sensor system 1, for instance. Such a sensor system 1 can, for example, be worn on the body or garment of a user 2 as a portable component, a so-called wearable device. The sensor system 1 can be integrated into a smartwatch, fitness tracker, or the like, for instance. However, any other concepts for acquisition and evaluation of the sensor values by means of sensors are possible too. For example, it is also possible that only one or more sensors, which transmit the sensor signals via a communication link, in particular a wireless communication link, to a spatially separate evaluation device, are provided on the user 2. The sensor values can, for instance, be transmitted to a smartphone, tablet computer or the like via a Bluetooth connection or the like.

Sensors that can be used include speed sensors, acceleration sensors, magnetic field sensors, a gyroscope, pressure sensors, for example, or any other sensors for acquiring user activities. Each one of the used sensors can provide a sensor value corresponding to the respective sensor variable. The respective sensor values can be acquired and provided at discrete points in time. The respective parameters to be monitored can be acquired periodically at specified time intervals, for example. Alternatively, it can, for instance, also be possible to output a new sensor value, possibly together with a corresponding timestamp, whenever there is a significant change, for example a change by more than a specified threshold value.

FIG. 2 shows a schematic illustration of a block diagram of a sensor system 1 comprising an apparatus 10 for processing sensor data. The sensor system 1 can include one or more sensors 20-i. As already noted, these can be any suitable sensors, which each acquire a parameter by means of sensors and output corresponding sensor values. The sensor values are output in time series. The time series with the sensor values each comprise a corresponding sensor value for discrete points in time. As already noted above, the sensor values can be provided conductively or via a wireless communication link to the apparatus 10 for processing the sensor data.

The apparatus 10 for processing the sensor data comprises an input device 11. This input device 11 can receive the sensor values from the sensors 20-i. If necessary, the received sensor values can also be temporarily stored in a memory of the input device 11.

A graph generator 12, which creates a graph from the received sensor values, is provided in the apparatus 10 for processing the sensor data as well. The individual nodes of the graph respectively comprise sensor values or data derived from the sensor values. The graph created by the graph generator 12 is then provided to a processing device 13. A graph neural network (GNN) is implemented in the processing device 13. The processing device 13 can thus process the graph provided by the graph generator 12 using the graph neural network. The processing device 13 can thereby in particular detect an activity. If the sensors 20-i are sensors that monitor the characteristics of a user, human activity can be detected from processing the graph in the processing device 13. The human activities that can be detected in this way can be sporting activities, for example. However, any other activities, in particular any human activities, that can be detected by the processing device 13 are generally possible too.

Optionally, a preprocessing device 15 can be provided in the apparatus 10 for processing the sensor data. This preprocessing device 15 can filter the sensor values received by the input device 11, for example. A band-pass filter or a notch filter can be implemented in the preprocessing device 15 for this purpose, for instance. However, any other approaches for filtering or preprocessing the sensor values are generally possible too. This can, for instance, be used to remove noise in the sensor values or other unwanted interference.

A transformation device 14 can furthermore be provided in the apparatus 10 for processing the sensor data as well. This transformation device 14 can carry out a time-frequency transformation of the sensor values, for example. The time-frequency transformation can in particular be a so-called wavelet transformation. The time-discrete sensor values can thus be converted into frequency components. If only frequency components in certain frequency ranges are relevant for the actions to be detected, only the relevant frequency components can be used to create the graph. Only low-frequency components may be relevant for the detection of user actions, for example, and used to create the graph. For the detection or monitoring of human activities, for instance, only low-frequency components in a range up to 15 Hz, for example, can be used. Limiting the frequency components in the sensor values makes it possible to minimize the amount of data needed to create the graph and for the subsequent evaluation in the graph neural network.

To create the graphs that form the basis for the subsequent evaluation using the graph neural network, sensor values from a specified time interval can be used, for example. As will be explained below, individual nodes can either be assigned values of sensors within a specified time window or, alternatively, nodes corresponding to points in time within a specified time window can be used to create the graph.

As shown in FIG. 3, the sensor values y can be provided at respective discrete points in time t1, t2, . . . . To create the data set for a node or to create a graph, values within a specified time window wi can be used. This time window wi can move continuously as time progresses.

If sensor values from a plurality of points in time ti are used to form a node, for instance, the sensor values within the time window w1 from t1 to t5 can be used to form a first node K1, for example. The time window can then be shifted by one step, so that the sensor values at the points in time t2 to t6 are used to form the next node w2.

If sensor values from a plurality of sensors 20-i are present at a point in time, these sensor values can be specified in the form of a vector, for example. To combine the sensor values of a plurality of points in time ti, the plurality of vectors can be combined into a common matrix, for instance. It goes without saying, however, that any other concepts for combining the sensor values are generally possible as well.

Once a plurality of nodes Ki have been formed with sensor values, the nodes can be linked to one another via edges to create a graph.

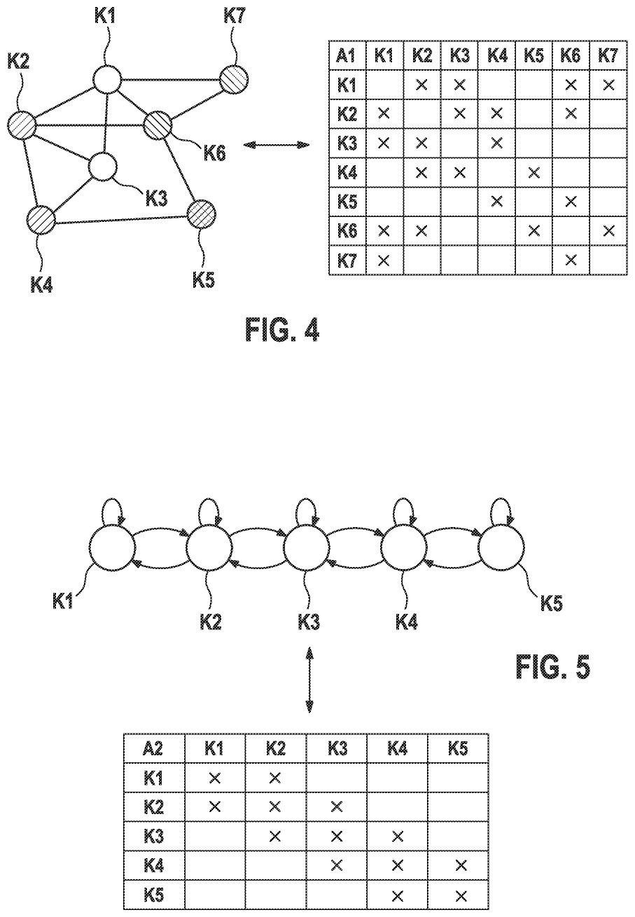

FIG. 4 shows a schematic illustration of the formation of a node according to one embodiment. Each node Ki comprises values of the sensors within a specified time window wi. As previously noted, the time window can be continuously moved forward. A first node K1 can therefore comprise the sensor values of the points in time t1 to t5, for instance, and a second node K2 can comprise the sensor values of the points in time t2 to t6, etc. It goes without saying that the selected number of five respective points in time should be understood merely as an example and does not in any way constitute a limitation of the present invention.

To specify the edges between the individual nodes Ki, similarities or matches in the sensor values of the individual nodes Ki can then be ascertained. The ascertained similarities, for example in the form of correlations or the like, can then be specified in a first dependency matrix A1. The ascertained nodes Ki together with the first dependency matrix A1 can thus be transmitted as a graph to the processing device 13 comprising the neural graph network.

FIG. 5 shows a schematic drawing to illustrate the creation of a graph according to another embodiment. The sensor values at a point in time ti can be specified in each node Ki here, for instance. The edges between the individual nodes Ki result from the temporal sequence of the respective nodes corresponding to the points in time ti. These edges can be specified by a second dependency matrix A2, for example. Edges of adjacent nodes can be specified by means of a one in the second dependency matrix A2, for instance, whereas nodes without a connection are represented as zero. The main diagonal therefore refers to the nodes themselves, whereas the values to the left and the right of the main diagonal refer to subsequent or preceding nodes. Such a dependency matrix A2 can therefore be defined in advance and does not have to be newly generated at runtime. This further reduces the computational effort required to process 10 the sensor data.

To create the graph, respective sensor values within a specified time window wi can be projected onto corresponding nodes. A first graph is therefore created using a first node K1 comprising the sensor values at the point in time t1 to a node Kn comprising the sensor values at a point in time tn, for example. A subsequent graph thus comprises the nodes K2 to Kn+1, etc. The time window wi consequently also moves continuously along the time axis.

The representation of the sensor values in the form of graphs, in particular in graphs in which the sensor values are formed with a sliding time window w, enables the evaluation of the sensor values using the aforementioned neural graph network. This makes it possible to improve the performance or minimize the required computing resources compared to conventional approaches and also compared to otherwise commonly used convolutional neural networks (CNN). This is particularly advantageous in particular for applications with limited computing power, such as in smart devices for monitoring body activities.

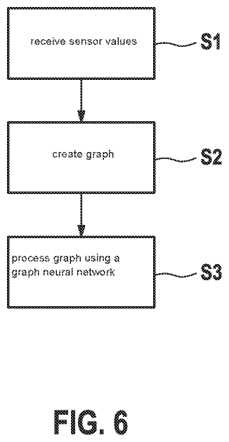

FIG. 6 shows a flowchart as it forms the basis for a method for evaluating sensor data according to one embodiment. The method can in principle comprise any steps as have previously been described in connection with the sensor system 1 and the apparatus 10 for evaluating sensor data.

In step S1, sensor values are received from at least one sensor 20-i. The sensor values are received as time series of sensor values at discrete points in time.

In step S2, a graph is created. The nodes of the graph comprise sensor values from the at least one sensor 20-i.

Lastly, in step S3, the graph is processed using a graph neural network. This enables activities, in particular human activities, to be detected.

In summary, the present invention relates to the evaluation of sensor data in order to detect an activity. For this purpose, it is provided to convert the sensor values into a graph and to process the graph using a graph neural network.

What is claimed is:

1. An apparatus for processing sensor data, comprising:
an input device configured to receive sensor data from at least one sensor, wherein the sensor data are received as time series of sensor values at discrete points in time;
a graph generator configured to create a graph, wherein nodes of the graph include the received sensor data from the at least one sensor; and
a processing device configured to process the graph using a graph neural network to detect an activity.

2. The apparatus according to claim 1 wherein each node of the graph respectively includes the sensor data from a predetermined number of successive points in time.

3. The apparatus according to claim 2, wherein the processing device is configured to process the graph using a predefined first dependency matrix, wherein the first dependency matrix specifies a similarity between two respective nodes in the graph.

4. The apparatus according to claim 1 wherein each node respectively includes the sensor data of a point in time and the graph includes a predetermined number of nodes with the sensor data from successive points in time.

5. The apparatus according to claim 4, wherein the processing device is configured to process the graph using a predefined second dependency matrix, wherein the second dependency matrix specifies edges between the nodes in the graph.

6. The apparatus according to claim 1, further comprising:
a transformation device configured to carry out a time-frequency transformation of the sensor data for the nodes of the graph, and wherein the nodes respectively include the transformed sensor data.

7. The apparatus according to claim 6, wherein the time-frequency transformation includes a wavelet transformation, and wherein the nodes respectively include only frequency components up to a predetermined cutoff frequency.

8. The apparatus according to claim 1, further comprising:
a preprocessing device configured to carry out filtering and/or preprocessing of the received sensor data.

9. A sensor system, comprising:
at least one sensor configured to monitor human activity and output sensor data as time series of sensor data of the monitored human activity; and
an apparatus for processing the sensor data, including:
an input device configured to receive the sensor data from the at least one sensor, wherein the sensor data are received as a time series of sensor values at discrete points in time,
a graph generator configured to create a graph, wherein nodes of the graph include the received sensor data from the at least one sensor, and
a processing device configured to process the graph using a graph neural network to detect an activity.

10. A method for processing sensor data, comprising the following steps:
receiving sensor data from at least one sensor, wherein the sensor data are received as time series of sensor data at discrete points in time;
creating a graph, wherein nodes of the graph include sensor data from the at least one sensor; and
processing the graph using a graph neural network in order to detect an activity.
